(19) United States
(12) Patent Application Publication
(10) Pub. No.: US 2010/0269591 A1
(43) Pub. Date: Oct. 28, 2010

(54) ELECTROMAGNETIC - ACOUSTIC CONVERTER

(76) Inventors: Andrey Vasilievich Kirikov, Pforzheim (DE); Waldemar Dan, Pforzheim (DE); Vladimir Alexandrovich Britvin, Cherepovets (RU); Alexey Mikhailovich Kashin, Cherepovets (RU)

Correspondence Address: LADAS & PARRY LLP, 26 WEST 61ST STREET, NEW YORK, NY, 10023, US

(21) Appl. No.: 12/600,001

(22) PCT Filed: Mar. 25, 2008
(86) PCT No.: PCT/RU2008/000174

§ 371 Date: Jul. 9, 2010

(30) Foreign Application Priority Data
May 24, 2007 (RU) 2007119186

(51) Int. Cl. G01N 29/04

(52) U.S. Cl. 73/584

(57) ABSTRACT

An electromagnetic acoustic transducer (EMAT) relates to the field of nondestructive, in particular, ultrasonic inspection of materials and items and can be used for testing of rolled sheet and section steel, and also pipes. The EMAT comprises a case with a substrate, at least one inductor and a protector covering the inductor from the substrate backside in form of a ceramic plate, holes are formed in the substrate for air supply generating in course of operation an air cushion between the lower face of substrate and the object under test. According to the invention the ceramic plate is provided on the lower face of the substrate and has such size, that its exterior outline embraces the holes in the substrate, thus holes are formed in said plate, said holes are coaxial to holes in the case. Shape of the ceramic plate substantially coincides with the shape of the substrate lower face and its square is substantially equal to square of the lower face of the substrate. In other alternative embodiment of the invention the substrate is made from ceramics and formed integrally with the protector. The invention allows increasing sensitivity, interference protection and reliability of the ultrasonic inspection due to decrease in the acoustic coupling negative influence between the inductor and the protector, diminution of electric and electromagnetic coupling between the transducer and the object under test and decrease in level of electrical and electromagnetic interferences caused by this coupling.

### TECHNICAL FIELD

The invention relates to the field of nondestructive, in particular, ultrasonic inspection of materials and items and can be used for testing of rolled sheet and section steel, and also pipes.

### BACKGROUND ART

It is known an electromagnetic acoustic transducer (EMAT) according to RU 2295125 including an inductor or group of inductors, a case made of nonferromagnetic metal, and also a dielectric, more often, ceramic protector pasted-in the case around the inductors. The known transducer comprises a case, an inductor and a protector in form of a ceramic plate, intended for inductor protection against damages. The protector protects only the inductor from mechanical damages and has, as a rule, rather small sizes comparable to size of the inductor or the group of inductors and a shape corresponding to the inductors.

The working plane of the protector, as a rule, is on the same level with the working surface of the case or is a little recessed in it. It may be said that the protector is inside the substrate, it is “pasted-in” in it. As a rule, its working surface is not required to be matched with the surface shape of the object under test in view of small protector size. At such approach minimization of the protector size reduces extent of its periphery contacting and interacting with the case, and in whole favorably affects the EMAT operation life. Diminution of the case size, however, is restricted by size of the inductor or group of inductors.

Matched on the shape with the inspected object the substrate includes compressed air outlets and is responsible for forming an air cushion. It is the substrate which is a main element forming the air cushion and determining efficiency of its operation in the known transducer. The shape of the substrate working surface always corresponds to the object under test, since the substrate is an element of EMAT which is, from geometrical point of view, the most approximate element to the inspected object during performing the ultrasonic check.

Deficiency of such EMAT is in rather high level of acoustic interferences caused by occurrences of acoustic stray coupling between inductors and protector and small size of the protector.

When a pulse of current flows through the inductor which is placed, as a rule, in a service area of strong magnet field, the Lorentz force affects the inductor which force is proportional to product of the inductor current, number of turns of the inductor and induction value of the magnetic field in the working area.

Due to occurrence in practice of inevitable acoustic coupling between the inductor and the protector, elastic vibrations are generated in the latter propagating to closely situated borders of the protector, reflected then from these borders and coming back in the inductor zone, generating electrical pulses therein which can make interference for reception of useful signals from the object under test.

Deficiency of such EMAT is also their rather low interference protection caused by occurrences of stray electromagnetic coupling between metal details of the transducer (substrate) and the inspected object.

The reason of possible negative influence on validity of ultrasonic testing of electromagnetic coupling between EMAT and the item under test is in the following.

When performing ultrasonic inspection of moving details on transport lines, currents flow on the surface of the latter; these currents are caused by inhomogeneity of potentials of the transport system elements and high strength of electromagnetic field characteristic for up-to-date production of rolled metal and pipes. Potential of each particular portion of the sheet can have values essentially differing, from the point of view of EMAT application, from the “zero point” potential. Therefore when the metal substrate contacts the object under test, this creates conditions for flowing of equalizing currents through metal elements of the transducer and shields of the cable connecting the EMAT with an input device (preamplifier). Considerable amplitude and a wide frequency spectrum of the interference caused by these phenomena can lead to essential decrease in sensitivity and reliability of the ultrasonic inspection.

High probability of interference generation occurs not only at immediate contact of the metal substrate and the inspected item, but also at small clearance therebetween that is caused by capacitive coupling “substrate-metal under test”.

A source of interference can also be created by currents induced by sounding pulse in the shield of cable connecting the transducer with electronic systems, and also the inductor on the surface of the inspected item. In case of small clearance characteristic for the air cushion, a strong capacitive coupling is generated between surface of the inspected object and the metal substrate. This coupling can lead to current resonance excitation in the shielding and earthing circuits, in particular, in the shield of the cable connecting preamplifier with EMAT. This specific type of interference appears as essential “delay” of sounding pulse on A-evolvent of the received signal

Other deficiency of the EMAT having a protector with size and shape corresponding to the inductor or group of inductors is low mechanical, temperature and erosive durability of such construction.

The air cushion is intended for effective protection of the transducer against temperature and abrasion. At the same time, the metal under test may have unevennesses, protruding defects on the surface and deviations of shape from the nominal. This determines possibility of direct mechanical contact of the EMAP with item and, as consequence, its damage. Besides, the solid particles of calx torn off by compressed air flow forming the air cushion, being accelerated to high speed, render erosive, destroying effect to the transducer working surface.

Substrate metal in all practically significant cases is a softer material in comparison with ceramics of which the protector is produced. Scores, grazes local attritions sharply reduce efficiency of the air cushion. Difference of physical properties of the materials present in the air cushion zone defines non-uniform mechanical and erosive wear of the transducer. The adhesive joint between the ceramics periphery and the substrate is subject to especially intensive erosion. In course of high-temperature ultrasonic inspection the “heating-cooling” cycles also negatively influence service life of the EMAT because of difference in expansion factors of used materials.

### SUMMARY OF INVENTION

It is an object of the invention to increase sensitivity, interference protection and reliability of the ultrasonic inspection due to decrease in the acoustic coupling negative influence between the inductor and the protector, diminution of electric and electromagnetic coupling between the transducer and the object under test and decrease in level of electrical and electromagnetic interferences caused by this coupling.

Another object of the invention is to raise manufacture adaptability of the transducer and improve its service properties due to improving of the air cushion efficiency, increase of mechanical strength and erosive durability of the transducer.

These and also other objects are achieved with the electromagnetic acoustic transducer comprising a case with a substrate, at least one inductor and a protector covering the inductor from the substrate backside in form of a ceramic plate, holes are formed in the substrate for air supply generating in course of operation an air cushion between the lower face of substrate and the object under test, according to the invention, the ceramic plate is provided on the lower face of the substrate and has such sizes that its exterior outline embraces the holes in the substrate, thus holes are formed in said plate, these holes are coaxial to holes in the case.

The ceramic plate square can be substantially equal to square of the lower face of the substrate, and its shape preferentially substantially coincides with the shape of the substrate lower face.

Preferably the ceramic plate is rigidly fixed to the substrate lower face, e.g. adhered.

Preferably, the number of holes in the substrate and matching holes in the ceramic plate is not less than two.

Besides, preferably thickness of the ceramic plate is constant and is equal from 0,1 to 5 mm depending on type and size of the inductor, type and properties of excited and/or received elastic vibrations, environmental conditions and required sensitivity of the ultrasonic inspection.

The above stated objects are also achieved by that, the electromagnetic acoustic transducer comprises a case with a substrate, at least one inductor and protector covering thereof from the side of substrate, the protector has a form of ceramic plate, thus holes in the substrate are provided for air supply forming an air cushion in process of operation between the substrate and the object under test, according to the invention the substrate is made from ceramics and formed integrally with the protector.

The ceramic protector of the electromagnetic acoustic transducer according to the present invention is an element jointly forming the air cushion and determining operational durability of EMAT. Homogeneity of the material present in zone of aggressive effect of the object under test, high resistance properties of ceramics in relation to friction, deterioration, mechanical damages, erosion, temperature effect, render a strongly pronounced positive role in increasing of operational durability of EMAT.

### BRIEF DESCRIPTION OF DRAWINGS

FIG. 1 schematically shows a cross-sectional view of the first embodiment of the electromagnetic acoustic transducer according to the present invention;

FIG. 2 illustrates the second embodiment of the electromagnetic acoustic transducer according to the present invention.

### BEST MODE FOR CARRYING OUT THE INVENTION

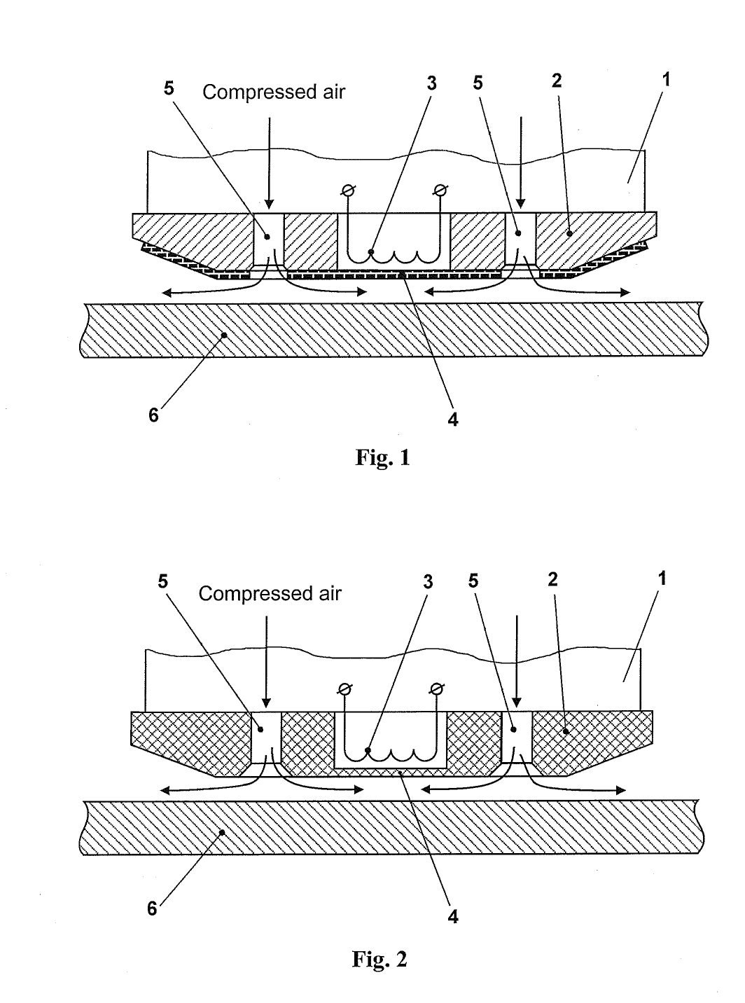

Shown in FIG. 1 electromagnetic acoustic transducer (EMAT) includes case 1 (illustrated symbolically) fixed thereto from the side faced to the inspected object 6 substrate 2 with holes 5 for air supply, inductor 3 provided in the substrate and ceramic protector 4. Other elements of EMAT, such as concentrator, magnetic circuit, connecting cable are conventionally not shown.

The substrate 2 is made from aluminium or aluminium alloy, and the ceramic protector 4 is formed in form of a ceramic plate of preferentially constant thickness. The ceramic plate forming protector 4 is made of such size that its periphery embraces holes 5 in substrate 2. Preferably the area of a ceramic plate substantially is equal to area of the lower face of substrate 2, and the shape of the ceramic plate substantially coincides with the shape of the lower face of substrate 2. The ceramic plate is rigidly fixed to the lower face of substrate 2, e.g. adhered thereto. Holes are foamed in the ceramic plate, these holes are coaxial to holes 5 in substrate 2. Preferably number of holes in substrate 2 and matching them holes in the ceramic plate is not less than two.

The construction thickness and material of the ceramic plate (protector 4) should satisfy the following condition:

C₀<<1/(2πf₀)²·L_{eq}, where

C₀—capacitance between EMAT and the object under test in operating position;

f₀—central frequency in sounding pulse spectrum;

L_{eq}—equivalent inductivity of the circuit “inspected object-preamplifier-cable shield-EMAP case”.

For flat EMAT protectors intended for inspection of rolled sheets C₀ is calculated by formula of plane capacitor:

C₀=εε₀S/d, where

ε—dielectric conductivity of the substrate material;

ε₀—dielectric constant, ε₀˜8.85×10⁻¹² F/m;

S—square of the dielectric plate (substrate);

d—thickness of the dielectric plate.

It was found that sufficient thickness of the ceramic plate is in range from 0,1 to 5 mm depending on type and size of the inductor, type and properties of excited and/or received elastic vibrations, environmental conditions and required sensitivity of the ultrasonic inspection.

Comparatively large size of protector 4 defines decrease in natural acoustic noise of the transducer. On the large path essential reduction in noise signals energy excited in the protector is ensured. In some cases, for example, at the rolled sheet inspection, the useful signals analysis is completed long before emersion of parasitic pulses reflected from the edges of ceramic plate—protector 4.

Stabilization and decrease in influence of electromagnetic coupling between the transducer and the inspected item are caused by presence of the dielectric ceramic plate between them ensuring absence of conductive coupling and essential diminution of capacitive coupling between EMAT and the object under test.

Thus, the EMAT protector functions according to the invention are extended: except the usual protection of inductors the protector has a function of forming an air cushion and protection of all working surface of the transducer against aggressive effect of the inspected object—erosive, mechanical, temperature.

Besides, the protector according to the present invention allows suppressing parasitic acoustic signal, to provide galvanic isolation of EMAT from the object under test and to stabilize and decrease capacitive coupling between EMAT and the inspected item.

FIG. 2 shows the second embodiment of the invention which in even more extent promotes capacitive coupling decrease between EMAT and the object under test. In this embodiment of the invention, unlike the above presented embodiment, substrate 2 and protector 4 are made integrally of ceramics. This allows practically guaranteed to avoid resonant phenomena in the screening circuits and in even more extent to suppress acoustic disturbance.

As a result of the carried out tests it was found that in comparison with the known transducer, the EMAT service life according to the present invention incremented approximately on 25%, and level of natural acoustic noise decreased on 6-8 dB.

1. An electromagnetic acoustic transducer comprising a case with a substrate, at least one inductor and a protector covering the inductor from the substrate backside in form of a ceramic plate, holes are formed in the substrate for air supply generating in course of operation an air cushion between the lower face of substrate and the object under test, characterized in that the ceramic plate is provided on the lower face of the substrate and has such sizes that its exterior outline embraces the holes in the substrate, thus holes are formed in said plate, said holes are coaxial to holes in the case.

2. The electromagnetic acoustic transducer according to claim 1, characterized in that the square of the ceramic plate is substantially equal to the square of the lower face of the substrate.

3. The electromagnetic acoustic transducer according to claim 1, characterized in that the shape of the ceramic plate substantially coincides with the shape of the substrate lower face.

4. The electromagnetic acoustic transducer according to claim 1, characterized in that the ceramic plate is rigidly fixed to the substrate lower face.

5. The electromagnetic acoustic transducer according to claim 4, characterized in that the ceramic plate is adhered to the substrate lower face.

6. The electromagnetic acoustic transducer according to claim 1, characterized in that the number of holes in the substrate and matching holes in the ceramic plate is not less than two.

7. The electromagnetic acoustic transducer according to claim 1, characterized in that the thickness of the ceramic plate is equal from 0,1 to 5 mm depending on type and size of the inductor, type and properties of excited and/or received elastic vibrations, environmental conditions and required sensitivity of the ultrasonic inspection.

8. An electromagnetic acoustic transducer comprising a case with a substrate, at least one inductor and protector covering thereof from the side of substrate, the protector has a form of a ceramic plate, thus holes in the substrate are provided for air supply forming an air cushion in process of functioning between the substrate and the object under test, characterized in that the substrate is made from ceramics and formed integrally with the protector.
